(19) United States
(12) Patent Application Publication
(10) Pub. No.: US 2013/0074982 A1
(43) Pub. Date: Mar. 28, 2013

(54) Methodology and Apparatus for Storing and Dispensing Liquid Components to Create Custom Formulations

(71) Applicants: Justin Echterling, Gurnee, IL (US); Senthil Muthuswamy, Gurnee, IL (US)

(72) Inventors: Justin Echterling, Gurnee, IL (US); Senthil Muthuswamy, Gurnee, IL (US)

(73) Assignee: GFI Innovations, Inc., Gurnee, IL (US)

(21) Appl. No.: 13/628,762

(22) Filed: Sep. 27, 2012

Related U.S. Application Data
(60) Provisional application No. 61/540,372, filed on Sep. 28, 2011.

(51) Int. Cl. B65B 3/04; B67D 1/00

(52) U.S. Cl. 141/10; 222/55; 141/83; 222/144.5

(57) ABSTRACT

The invention is directed to methodologies and apparatuses in which materials are dispensed in order to create a desired finished product. The invention permits the dispensing of a specific amount of material in a controllable, metered fashion. The invention includes a plurality of storage containers may be positioned within (or eternal to) the machine or equipment in a way that allows the containers to be rotated on an axis such that the material inside each container is turned over on itself resulting in the material being thoroughly dispersed within itself. Additionally, the containers, connectors and hosing prevent the material to be dispensed from coming in contact with the air. This would prevent material inside the containers from drying.

### CROSS-REFERENCE TO RELATED APPLICATIONS

This application is a non-provisional application of, and claims priority to, U.S. Provisional Application Ser. No. 61/540,372, filed Sep. 28, 2011.

### FIELD OF THE INVENTION

The present invention relates to methodologies and apparatuses in which materials are dispensed in order to create a desired finished product. The invention permits the dispensing of a specific amount of material in a controllable, metered fashion.

### BACKGROUND

The present invention builds upon the methodologies and dispensing equipment disclosed in U.S. Pat. Nos. 8,011,394 and 7,198,073, both owned by GFI Innovations, Inc., the assignee of the present application, and both of which are incorporated by reference in their entirety. Reference and incorporation is specifically made to the dispensing equipment disclosed therein, including the human-machine interface, computer, scale, sensors, valves, material bags and containers, fluid lines, pistons, piston assemblies, and equipment frame. Reference and incorporation is also specifically made to the methodologies of accurately measuring the material as it is dispensed, sensing and weighing the material, pulsing additional material and cutting off the flow of material after a targeted amount and weight has been reached. This application incorporates all of the equipment and methodologies disclosed therein and builds upon them as described below and shown in the drawings.

### SUMMARY OF THE EMBODIMENTS

The present invention looks to improve on the methodology and apparatus in which materials are dispensed in order to create a desired finished product based on a prescribed mixture of a number of material components typically divided according to their individual requirements by percentages. The present invention additionally looks to improve upon the dispensing of a specific amount of material in a controlled, metered fashion.

In one exemplary embodiment, a material dispenser may include a plurality of storage containers positioned within (or eternal to) the dispenser in a way that allows the containers to be rotated on an axis such that the material inside each container is turned over on itself resulting in the material being thoroughly dispersed within itself. In another aspect of the invention, the containers, connectors and hosing prevent the material to be dispensed from coming in contact with the air. This prevents the material inside the containers from drying.

In another exemplary embodiment, a material dispenser includes a movable cabinet containing at least one material container containing material, the movable cabinet is rotatable to cause the material within the container to mix thoroughly. The dispenser includes a manifold operatively connected to the at least one container. The dispenser also includes a computer which controls the discharge of material from the container and a sensor that may be positioned external to the container and external to the discharged material for detecting the material exiting the dispense valve of the container. The sensor may provide feedback regarding the presence of the discharged material to the computer. The dispenser may include a scale for detecting the amount of material discharged from the container, and the scale may provide feedback regarding the amount of material discharged to the computer. With the dispenser, the computer controls the pulsing of additional material based on the feedback from the sensor and the scale until a targeted amount of material has been discharged from the container.

In another exemplary embodiment, a method of dispensing material includes providing a dispenser having a movable cabinet contained therein. The movable cabinet may contain one or more containers holding material and may be rotatable about a pivot point to cause the material within the containers to mix. The method further includes providing an apparatus to start and stop the discharge of material from the at least one container, and providing a computer to control the amount of discharged material. The method also includes sensing the material exiting the container, the sensing being performed external to the discharged material, and weighing the discharged material. In response to the sensing and weighing of material, the method includes providing feedback regarding the sensing and weighing of material to the computer, thereafter the computer determines whether a targeted weight has been reached. If it has not, the method includes causing additional material from the container to discharge based on the feedback provided to the computer. The method may also include the step of sensing the discharge of a small amount of material discharged from the container and providing feedback to the computer that the small amount of material has been sensed.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an isometric view of an exemplary dispenser.

FIG. 2 is a front view of the dispenser of FIG. 1.

FIG. 3 is a right side view of the dispenser of FIG. 1.

FIG. 4 is an isometric view of the dispenser of FIG. 1.

FIG. 5 is a front view of the dispenser of FIG. 1.

FIG. 6 is a right side view of the dispenser of FIG. 1.

FIG. 7 is a top view of the dispenser of FIG. 1.

FIG. 8 is an isometric view of the multiple storage compartments of the dispenser of FIG. 1.

FIG. 9 is another isometric view of the multiple storage compartments of the dispenser of FIG. 1.

FIG. 10 is another isometric view of the multiple storage compartments of the dispenser of FIG. 1.

FIG. 11 is a view of the inside of the dispenser of FIG. 1 illustrating an exemplary manifold.

### DETAILED DESCRIPTION OF THE EMBODIMENTS

The present invention may be embodied in many forms and many methodologies. As used herein, the following terms have the following broad meaning as understood by those of skill in the art. Note that these definitions are intended to simply assist the reader in understanding the terms used herein and are not meant to provide a limiting definition to each term. The term “material” or “base material” means a flowable, non-solid substance, such as liquid, paste or powder, or any other substance capable of dispensing. The term “formulation” means a prescribed recipe of a number of material components typically divided, according to their individual requirements, by percentages that, when dispersed or thoroughly mixed together, create a desired finished product. The terms “container” or “material container” mean any and all devices or structures, in which one or more materials may be contained, held, packaged into, received in, stored in or used as delivery package, including without limitation any and all structures identified herein. The term “human-machine interface” means one or more devices that allow for an interface between those devices and humans for the control of equipment or processes of equipment, and more generally may be defined as the layer or device that separates a human that is operating the equipment from the equipment itself.

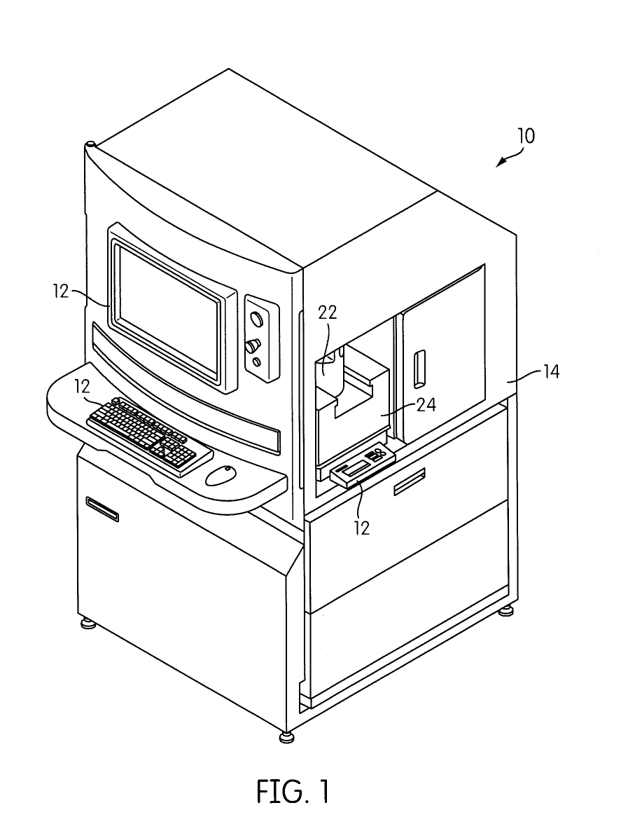

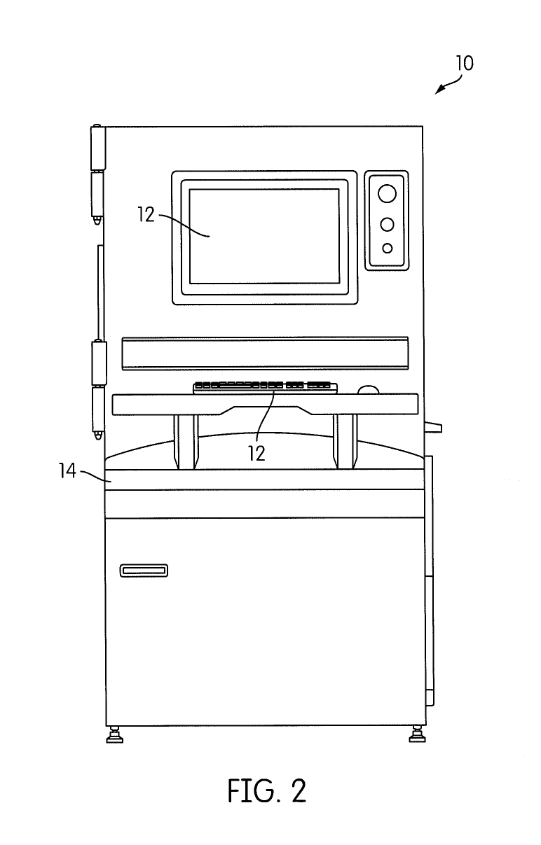

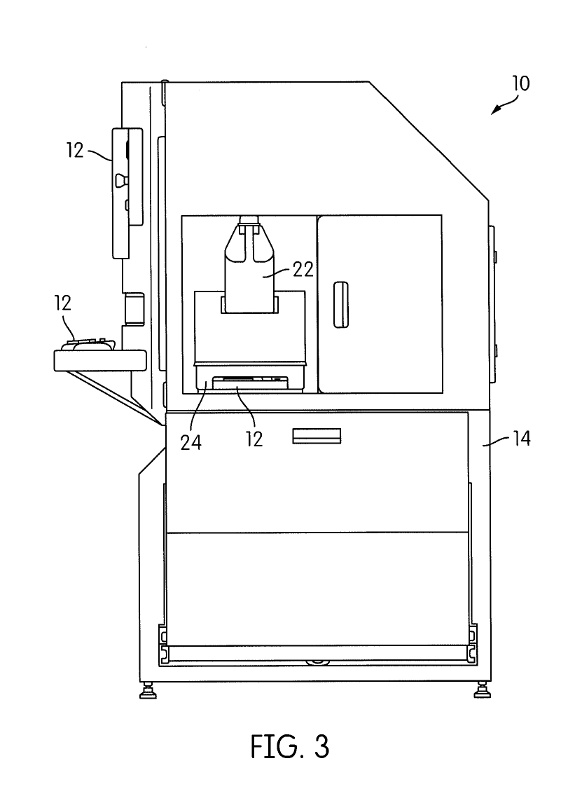

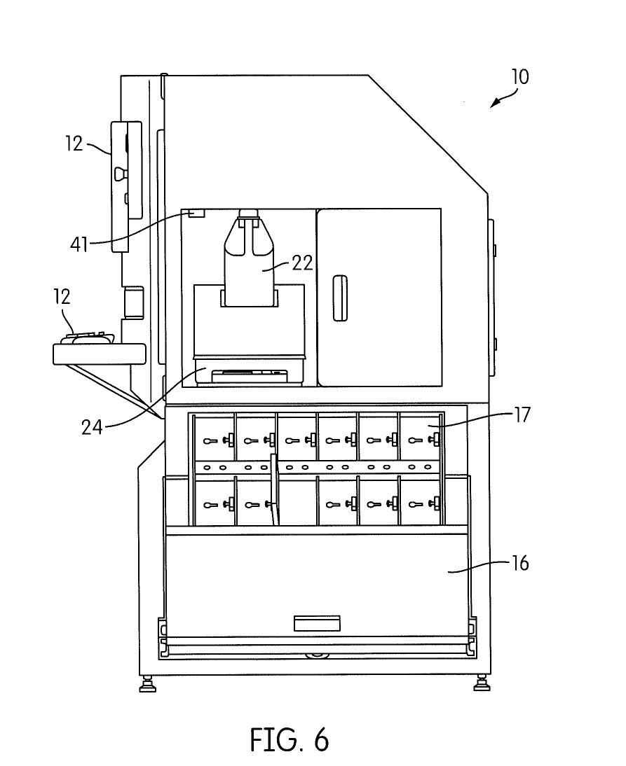

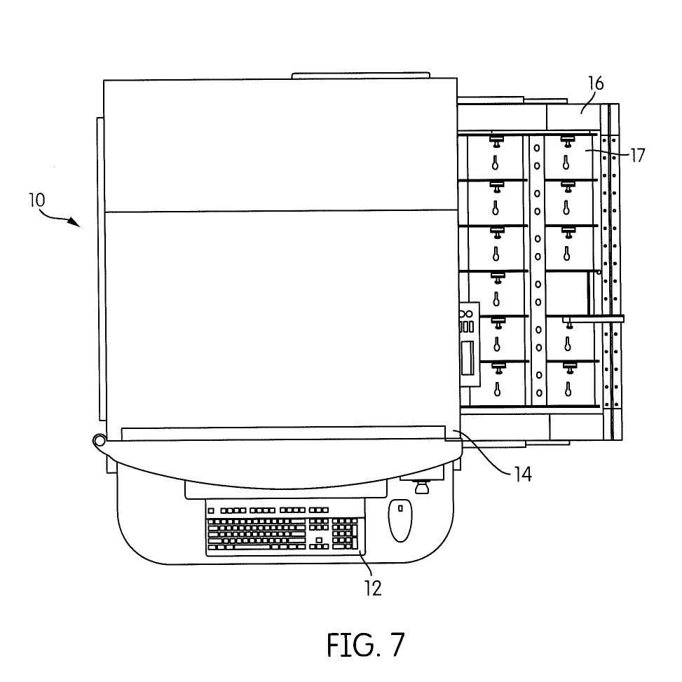

Referring to the figures, various views of an exemplary dispenser 10 of the invention are depicted. Referring to FIGS. 1-7, the exemplary dispenser 10 may include a human-machine interface 12 stored within a dispenser frame 14. The human-machine interface 12 may include a computer, monitor or display, and keyboard or other means of inputting information or otherwise interfacing with the computer. The frame 14 may define an enclosed structure that houses the components used to control the dispensing of material. The frame may include an opening and support structure to contain a scale 24 and may define a space to receive a receiving container 22.

The frame may also include a compartmented cabinet 16 which supports a number of bags or containers of material stored within individual compartments 17. The individual compartments 17 may include a door or flap 19 that permits easy access to the compartment. Each of the doors or flaps may further include holes or apertures 27 through which supply hoses may run. The supply hoses will connect the containers within the compartments to the supply manifold 23 and are used to transfer the material within the containers to the manifold for eventual dispensing. In one embodiment, the cabinet 16 may include twelve 3-gallon bags or containers. In an exemplary application, each container may contain a single base material and may be used in some combination with a blend of a custom formulation. In an alternative embodiment, the dispenser 10 may also incorporate one or more pumps that may pull materials from bulk containers (for example, 55-gallon drums).

The dispenser 10 may use a metering pump which will draw the material from the container via vacuum. The material is then transferred to the manifold valve system 23 and eventually into the receiving container 22, which may sit on a scale 24. The manifold valve system 23 may be movable within the frame 14.

In a general, exemplary operation of the dispenser 10, the operator would interface with the human-machine interface which upon receiving the inputted parameters from the operator would send a signal to either a bag pressure actuator or pump. The human-machine interface would signal a supply valve to open entirely and the pressure actuator to operate or the pump to start. The material from the storage container housed within the compartment would then move through the supply tubes and through a dispense valve which will open upon pressure applied from the material and then past a material sensor which detects the presence of a volume of material. The material then dispenses into the receiving container which sits upon a scale.

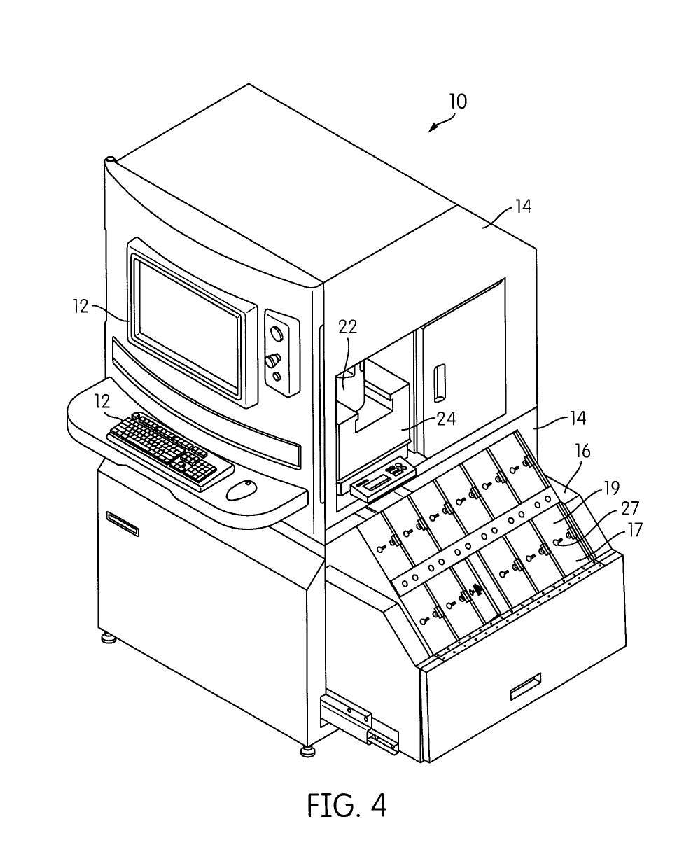

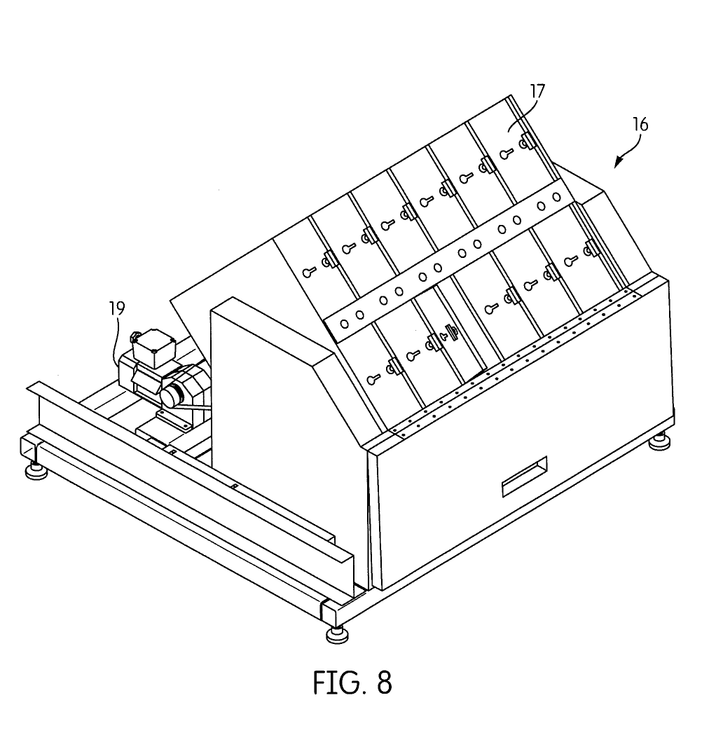

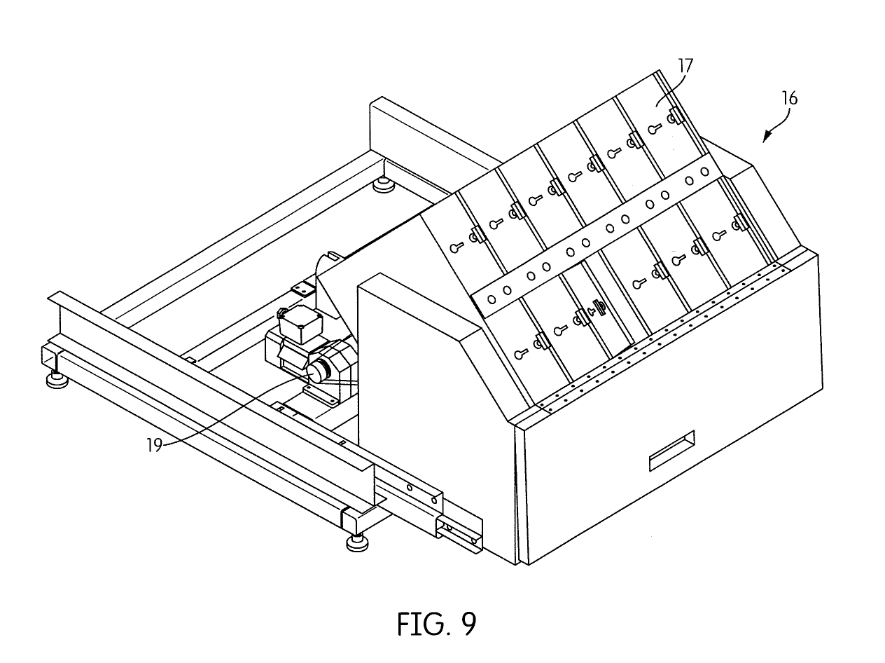

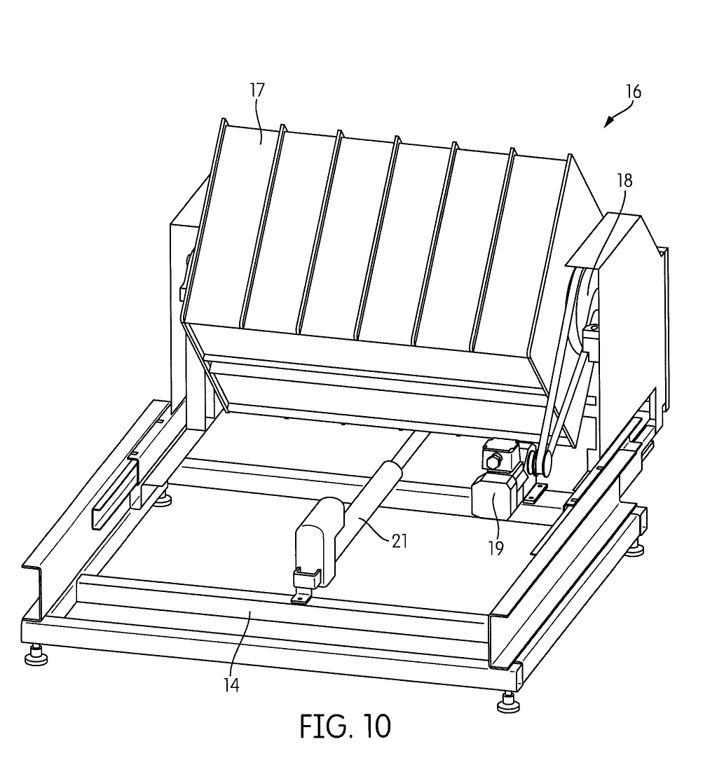

In one aspect of the dispenser 10, the compartmented cabinet 16 is extendable from the frame 14 (as shown in FIGS. 4-12) and can rotate approximately 180 degrees around a pivot point 18 or axis (as shown in FIG. 10). A motor and belt-driven system 19 may be used to cause the rotation. Other similar systems may be used to effect the rotation of the compartmented cabinet 16 without departing from the spirit and scope of the invention. This rotation of the cabinet 16 allows the ink or material to mix within the bag or container within each compartment without any outside interaction via mixing blades or the like. More specifically, the rotation of the containers around the pivot point causes the material inside each container to be turned over on itself resulting in the material being thoroughly dispersed within itself.

In an alternative embodiment, the cabinet may rotate less than 180 degrees and may rotate in opposite directions, or in alternating directions, and still effectively mix the material within the container. In yet another alternative embodiment, one or more of the individual compartments may be rotated thus permitting selective rotation of a particular material container.

In an exemplary aspect of the invention, the system also provides hermetic sealing which avoids any contact of air to the material stored within the container. In this embodiment, the container connection point has a quick disconnect which allow for quick change out, but significantly no air will contaminate and thus cure the material.

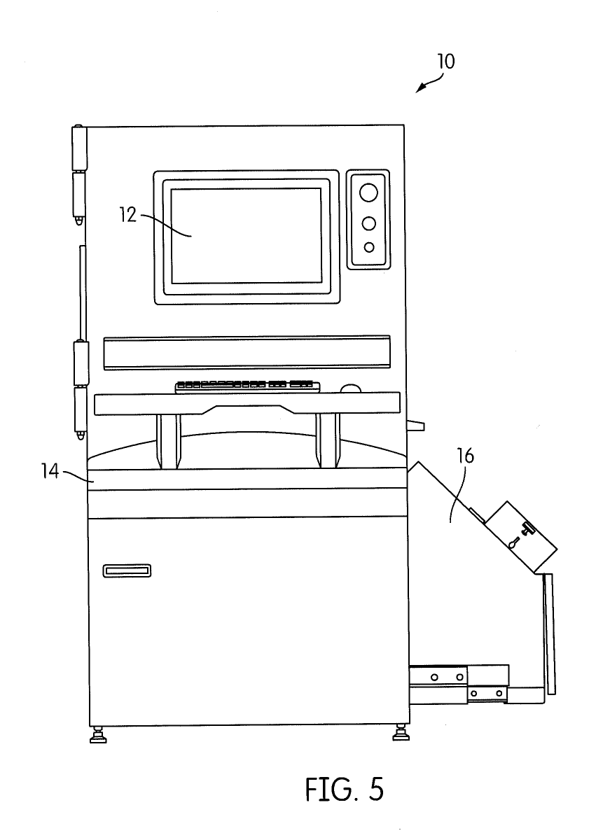

In an alternative embodiment, as shown in FIG. 10, a piston assembly 21 may be mounted between the frame 14 of the dispenser 10 and the compartmented cabinet 16. The piston assembly 21 may be used to cause the extension of the cabinet 16 relative to the frame 14. This permits the cabinet 16 to be moved out of the frame of the dispenser 10 (as shown in FIGS. 4 and 5) for easier loading and unloading of containers or bags within the cabinet.

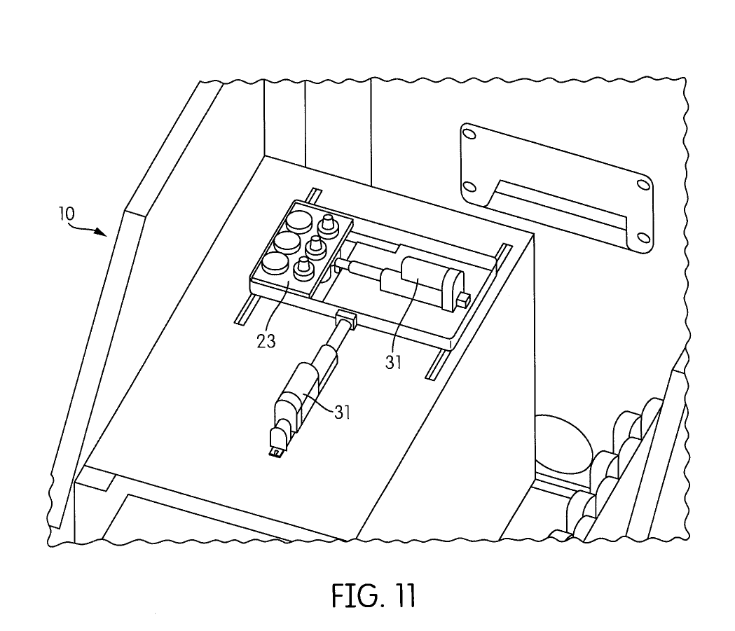

The manifold valve system 23 may be movable within the frame 14 through the use of actuators 31, as shown in FIG. 11. The manifold valve system 23 may use a “duckbill” valve that will allow ink to be dispensed and when finished the pump is run backwards for a short time thus providing a small amount of vacuum on the dispense valve that will seal the valve and avoid any air contamination to the product.

The equipment may include the scale 24 to weigh the material after it is dispensed. Alternatively, the dispenser 10 may use a feature that can monitor the pump revolutions and provide a dispense without the use of a scale.

In one exemplary embodiment, a plurality of storage containers may be positioned within (or eternal to) the dispenser 10 in a way that allows the containers to be rotated about an axis such that the material inside each container is turned over on itself resulting in the material being thoroughly dispersed within itself. In one embodiment, this could be a continuous rotating action. In an alternative embodiment, this could be a programmed timing sequence based on the mixing requirements of the individual materials.

In another aspect of the invention, the containers, connectors and hosing prevent the material from coming in contact with the air. In this aspect of the invention, the containers could be sealed in a way that prevents the material from coming in contact with the air until the time the material is dispensed into the receiving container. This will prevent material inside the containers from drying. In one embodiment, dry-fit connectors that connect the bag to the hoses may be used to provide an air-free connection. This prevents the material in the container, hoses and the dispensing valve from reacting to the air or chemicals that might be in the material and that might cause the material to either dry or change its properties.

In yet another aspect of the invention, a coating may be applied to the components of the dispenser, namely on the dispensing valve itself, inside the hoses that contain the material or inside the containers that store the material. This coating could amplify repellency of any fluid material, preventing material from adhering to those parts. This applied coating could help prevent the drying or adhesion of any material to any of the whetted components of the equipment, namely and most significantly at the point where the material is expelled from the dispenser (the dispense valve). The drying of material at the dispense valve is the single most significant problem with existing dispensing machines. The drying at the valve could result in dispensed batches of ink being ruined (dried chunks of material falling into the batch), the equipment failing to work or the requirement of expensive ongoing maintenance procedures. In one embodiment, coatings may include patternable superhydrophobic coatings, including a coating called NeverWet manufactured by Ross Technologies. This coating may be applied to such surfaces that keep coated surfaces clean and dry and prevent adhesion of any material to the treated surface.

With the embodiments disclosed herein there are numerous materials that could be used with the dispenser 10, including without limitation, food, drugs, ink, paint, health and beauty products (hair coloring, nail polish, foundations), adhesives, and any other material or product needing to be dispensed. The result of the present invention is a machine that stores, maintains and delivers materials required for any fluid formulation dosing need.

In another aspect of the invention, the dispenser 10 may be used to dispense any given amount of material using an automated machine from one or more of the base material containers, each of which may incorporate a pressure-responsive, proportional dispense valve. The container with the dispense valve is capable of effectively stopping the flow of the material through regulation of pressure applied to the material residing within the container.

In an exemplary embodiment, as base material is expelled through the pressure-responsive, proportional dispense valve, the valve will open rollingly to permit the base material to flow through, and the base material is sensed by a sensor 41 which, along with the scale 24 sends information to the human-machine interface 12 and computer to increase, decrease or discontinue the pressure being applied in the container. When the weight of base material being expelled into receiving container 22 achieves a predetermined weight, the computer may send a signal to the pressure actuator to expel a minimal amount of base material from the container (commonly referred to as “pulsing”) in order to expel small amounts of base material to “pulse” up to the required base material amount as determined as a percentage of the total amount of material entered into the computer through the human-machine interface. The same process is completed for each base material required of a custom formulation.

Still another exemplary embodiment of the dispenser 10 holds one or a plurality of containers and, within each resides a single base material which, if required of a desired formulation, in some calculated proportion, is used. The dispenser may also include a human-machine interface and scale. In this method of use, the operator inputs into the human-machine interface a value of the desired finished amount of a custom formulation to blend. The human-machine interface calculates the total weight of each of the base material components required to create the target amount. The operator then positions a container to the dispense position. A pressure actuator pushes the base material through a proportional pressure responsive dispense valve that opens and closes in a rolling manner into a receiving container residing on a scale. As the base material is expelled through the dispense valve and falls into the receiving container the base material is weighed by the scale and the operator may increase, decrease or discontinue the pressure being applied to the material container by the pressure actuator to provide the calculated amount. When the operator discontinues applying pressure to the pressure actuator the dispense valve effectively stops expelling the base component from the material container. The operator then reads the scale value and determines if more base material is required to reach the calculated amount. The operator repeats the above steps until the calculated amount required of the formulation is attained. When the calculated amount is attained the operator positions the next material container required of the formulation, if another is required, into a position for dispensing and repeats the process until the calculated amount of each base material components of the required formulation have been dispensed into the receiving container.

Yet another embodiment of the dispenser 10 holds one or a plurality of containers and in which resides a single base material which, if required of a desired formulation, in some calculated proportion, is used. In one method of use, the operator inputs into the human-machine interface a value of the desired finished amount, i.e., the target amount in a value of total weight, of a custom formulation to blend. The human-machine interface calculates the total weight of each of the base material components required to create the target amount. The pressure actuator pushes the base material through a proportional pressure responsive dispense valve that opens and closes in a rolling manner into a receiving container residing on a scale. As the base material is expelled through the valve, the base material is sensed by a sensor which, along with the scale, sends feedback information to the human-machine interface to increase, decrease or discontinue the pressure being applied to the material container by the pressure actuator to provide the calculated amount. If the amount of base material expelled does not equal the calculated amount the human-machine interface recalculates the amount of base material required (the “recalculated amount”), recalculates the amount of pressure required of the pressure actuator to attain the recalculated amount, and sends a signal to the pressure actuator to expel the recalculated amount of base material from the material container. The process of expelling a base amount, receiving feedback from the sensor and the scale, calculating if more base material is required and, if required, recalculating the amount of pressure required of the pressure actuator to attain the total recalculated amount continues until the calculated amount is attained.

It is to be understood that the invention is not limited in its application to the details of construction and the arrangement of the components set forth herein. The invention is capable of other embodiments and of being practiced or being carried out in various ways. Additional and alternative dispensing methodologies are disclosed in U.S. Pat. Nos. 8,011,394 and 7,198,073, both of which are incorporated herein by reference in their entirety. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A material dispenser comprising:
a movable cabinet containing at least one material container containing material, the movable cabinet rotatable to cause the material within the container to mix;
a manifold operatively connected to the at least one material container;
a computer which controls the discharge of material;
a sensor positioned external to the at least one container and external to the discharged material for detecting the material exiting past a dispense valve, the sensor providing feedback regarding the presence of the discharged material to the computer, and
a scale for detecting the amount of material discharged from the container, the scale providing feedback regarding the amount of material discharged to the computer,
wherein the computer controls the pulsing of additional material based on the feedback from both the sensor and the scale until a targeted amount of material has been discharged from the container.

2. The material dispenser of claim 1 further comprising a plurality of material containers each containing material, the plurality of containers positioned within the movable cabinet.

3. The material dispenser of claim 1 further comprising a material reservoir for receiving the material discharged from the at least one container; the material reservoir positioned on the scale.

4. The material dispenser of claim 3 further comprising a human-machine interface.

5. The material dispenser of claim 1 further comprising an actuator for causing the material to be moved from the at least one container.

6. The material dispenser of claim 5 wherein the sensor detects the discharge of material from the container and signals the computer to control the actuator to exert a pressure on the material for a predetermined amount of time.

7. The material dispenser of claim 6 further comprising supply hoses connected between the container and the dispense valve, wherein the supply hoses and dispense valve may include a coating thereon.

8. The material dispenser of claim 6 further comprising a motor and belt driven system that rotates the movable cabinet.

9. The material dispenser of claim 8 wherein the feedback provided by the sensor and scale allow the computer to calculate the amount of additional material to be dispensed from the container, and to recalculate the amount of pressure and time exerted by the actuator until the targeted amount of material has been obtained.

10. The material dispenser of claim 9 wherein the material is ink.

11. The material dispenser of claim 7 wherein the material within the container and supply hoses is hermetically sealed from the outside air.

12. A method of dispensing material, comprising the steps of:
providing a movable cabinet containing at least one material container containing material,
rotating the movable cabinet to cause the material within the at least one container to mix;
providing an apparatus to start and stop the discharge of material from the at least one container,
providing a computer to control the amount of discharged material,
sensing the material exiting the container, the sensing being performed external to the discharged material,
weighing the discharged material, and in response to the sensing and weighing of material,
providing feedback regarding the sensing and weighing of material to the computer, wherein the computer determines whether a targeted weight has been reached, and if the targeted weight has not been reached, causing additional material from the container to discharge based on the feedback provided to the computer.

13. The method of dispensing of claim 12 further comprising the step of processing the sensed and weighed material by the computer.

14. The method of dispensing of claim 13 further comprising the step of sensing the discharge of a small amount of material discharged from the container and providing feedback to the computer that the small amount of material has been sensed.

15. The method of dispensing of claim 14 further comprising weighing the small amount of material discharged and providing feedback to the computer.

16. The method of dispensing of claim 15 wherein the computer recalculates the amount of material required to reach the targeted amount.

17. The method of dispensing of claim 16 further comprising the step of signaling an actuator to expel the recalculated amount of material from the container.
